(19) United States
(12) Patent Application Publication
(10) Pub. No.: US 2006/0269085 A1
(43) Pub. Date: Nov. 30, 2006

(54) METHOD AND APPARATUS FOR MIXING MUSIC

(76) Inventors: Chia-Chun Hsieh, Taipei Hsien (TW); Yi-Chung Liu, Taipei City (TW); Lung-Chun Chang, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/307,492

(22) Filed: Feb. 9, 2006

(30) Foreign Application Priority Data
May 25, 2005 (CN) 200510073859.6

(51) Int. Cl. H04B 1/00

(52) U.S. Cl. 381/119

(57) ABSTRACT

The present invention provides a method and an apparatus for mixing music. The method includes: utilizing a portable device to play an audio file, detecting a motion path of the portable device to generate a control signal, and mixing the audio file according to the control signal in order to mix a specific sound effect with a sound effect corresponding to the audio file, wherein the specific sound effect is selected from a plurality of sound effects.

### BACKGROUND OF THE INVENTION

1. Field of the Invention

The present invention relates to a method and an apparatus for mixing music, and more specifically, to a method and an apparatus for mixing music by detecting a movement of a mobile phone.

2. Description of the Prior Art

Mobile phones have enabled modern life to become increasingly convenient, so the popularity of mobile phones is significantly increasing. Mobile phones not only have a function of communication, but also have many additional functions making the mobile phone more useful and interesting. The mobile phones available on the market nowadays have an increasing number of additional functions, enabling users to play games, take photos, listen to music, mix ring tones etc. More mobile phones nowadays have a ring tone mixing function, so that the user can create a specific ring tone for their own mobile phone according to their personal preference.

A keyboard input method is typically utilized during a ring tone mixing process. That is, the user can select a melody stored in the mobile phone using the mobile phone keyboard, and then mix a ring tone with the selected melody. As mobile phone sizes become smaller and more compact, the size of individual keys on the keyboard becomes limited, often creating some inconvenience when utilizing the keyboard, and therefore when mixing ring tones.

### SUMMARY OF THE INVENTION

One of the objectives of the claimed invention is therefore to provide a method and an apparatus for mixing music, to solve the above-mentioned problem.

According to the claimed invention, a method for mixing music is disclosed. The method comprises: utilizing a portable device to play an audio file; detecting a motion path of the portable device to generate a control signal; and mixing the audio file according to the control signal in order to mix a specific sound effect with a sound effect corresponding to the audio file, wherein the specific sound effect is selected from a plurality of sound effects.

In addition, the claimed invention provides a portable device capable of mixing music. The portable device comprises: a storage device for storing an audio file; a control circuit, coupled to the storage device, for playing the audio file; and a detector, coupled to the control circuit, for detecting a motion path of the portable device to generate a control signal; wherein the control circuit mixes the audio file according to the control signal to mix a specific sound effect with a sound effect corresponding to the audio file.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is diagram of a mobile phone capable of mixing music according to the present invention.

FIG. 2 is a diagram of a first embodiment of a music-mixing interface according to the present invention.

FIG. 3 is a diagram of a second embodiment of the music-mixing interface according to the present invention.

FIG. 4 is a diagram of a third embodiment of the music-mixing interface according to the present invention.

### DETAILED DESCRIPTION

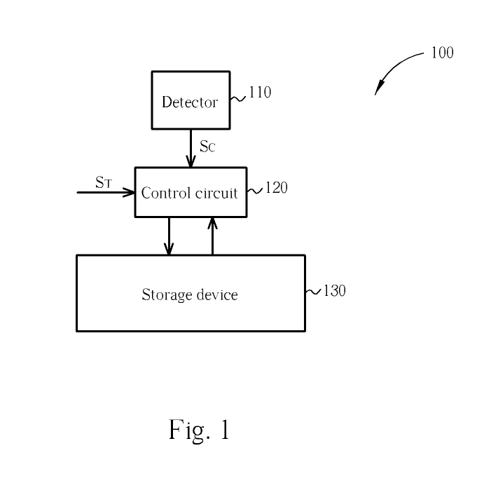

Please refer to FIG. 1. FIG. 1 is a diagram of a mobile phone capable of mixing music according to the present invention. The mobile phone 100 comprises a detector 110, a control circuit 120 and a storage device 130. In order to provide more flexibility for users' selections, the storage device 130 of the mobile phone 100 according to the present invention stores several audio files. The storage device 130 of the mobile phone 100 can be a built-in non-volatile memory, and the audio files are grouped according to different modes. For example, when the mobile phone 100 displays a menu for mixing ring tones, this means the mobile phone 100 provides the users with a plurality of modes to select. The audio files are grouped according to areas the audio files belong to, meaning that the audio files of different music types are divided into different groups according to attributes (i.e. areas) of the audio files. For example, there are four music types in the present invention, such as Asian, African, American, or European music.

Before the music-mixing process is started, a user selects a preferred music type through the user interface of the mobile phone 100. Assume the user selects African music. Several audio files in the African music group are shown on the user interface for the user to select. When the user selects one of the audio files, the control circuit 120 reads the audio file from the storage device 130 and then plays the audio file. The user can then listen to the music corresponding to the audio file.

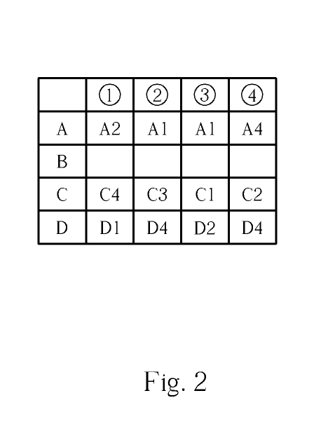

According to the present invention, a piece of music is composed of melodies generated by several instruments. Assume the selected music is composed of melodies generated by four instruments. The four instruments are represented as A, B, C, and D, wherein each instrument (A, B, C, D) can generate four different melodies. The selected music can be composed of 16 kinds of melodies. In the present embodiment, A1˜A4, B1˜B4, C1˜C4, and D1˜D4 are utilized for representing the 16 different melodies. In the implementation, three of the four instruments are selected as the predetermined instruments for the piece of music. A background music is composed of the 12 melodies generated by the three predetermined instruments, and the four melodies generated by the remaining instrument (i.e. not one of the three predetermined instruments) are provided for the users to select and mix into the background music. For example, when starting the mixing music process, the control circuit 120 repeatedly plays a plurality of sections of the selected audio file. Please refer to FIG. 2. FIG. 2 is a diagram of a first embodiment of a music-mixing interface according to the present invention. Assume the selected audio file comprises four sections. The control circuit 120 sequentially and repeatedly plays the four sections until the music-mixing process is accomplished. As shown in FIG. 2, three instruments, A, C, and D, are set to be predetermined instruments for the selected audio file. The instrument B is reserved for the user to select a preferred melody. The selected melody is mixed with the background music composed of melodies generated by the three predetermined instruments A, C and D.

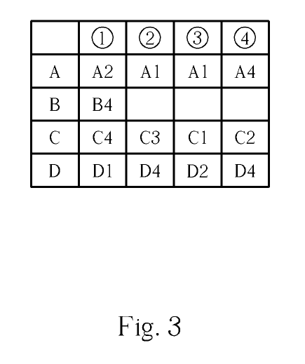

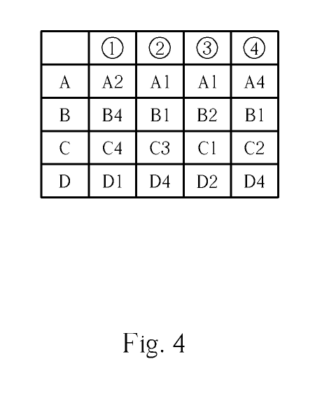

Next, the selection process of four melodies B1, B2, B3 and B4 generated by the instrument B is detailed. When the control circuit 120 plays the first section of the music file, the user can hear the background music composed of the melodies A2, C4 and D1. When the control circuit 120 plays the background music, the user can move his body and the music mixing-process can be initialized in this way. The mobile phone 100 held by the user generates a corresponding motion path when the user moves his body. Meanwhile, the detector 110 detects a motion path of the mobile phone 100 in each section to generate a control signal S_{C}, and transmits the control signal S_{C} to the control circuit 120. Afterwards, the control circuit 120 mixes a melody corresponding to the control signal S_{C} with the background music. In the present embodiment, four melodies B1, B2, B3 and B4 generated by the instrument B are provided for the user to select, where the four melodies B1, B2, B3 and B4 respectively correspond to four motion paths. When the detector 110 detects one of the four motion paths, the detector 110 generates a corresponding control signal S_{C}. For example, assume four motion paths “S”, “|”, “Δ” and “O” respectively correspond to the four melodies B1, B2, B3, B4. When the control circuit 120 plays a first section of the background music, the detector 110 detects the motion path of the mobile phone 100 is “O”. The control circuit 120 then adds the melody B4 into the first section of the background music, as shown in FIG. 3. FIG. 3 is a diagram of a second embodiment of the music-mixing interface according to the present invention. The arrangement of the first section of the background music is therefore accomplished. The above-mentioned procedures are repeated for the following sections. Please note that in each section, a motion path of the mobile phone 100 can be any one of the four motion paths and is not limited to be “O”. Assume the motion paths of the mobile phone 100 respectively corresponding to the second, third, and fourth sections are “S”, “|” and “S”, respectively. The results of the arrangements are shown in FIG. 4. FIG. 4 is a diagram of a third embodiment of the music-mixing interface according to the present invention. After the control circuit 120 has finished playing the fourth section, the control circuit 120 will play the first section again. At this time, if the detector 110 detects a different motion path (i.e. “Δ”), the melody B4 of the first section will be replaced with the melody B3. During the arrangement, if the detector 110 detects a new motion path in each section, the control circuit 120 replaces a current melody with a new melody according to a new control signal S_{C}.

The music-mixing process proceeds until the control circuit 120 receives a control signal S_{T}. When the control circuit 120 receives the control signal S_{T}, that means the current music-mixing process is accomplished. There are several ways to trigger the control signal S_{T}. The control signal S_{T} can be triggered by pressing a key on the keyboard. Alternatively, if the mobile phone 100 is a flip-style mobile phone (clamshell) or a slide-style mobile phone, the control signal S_{T} can be triggered by flipping or sliding the cover back, therefore ending the music-mixing process.

The above-mentioned detector 110 can be a motion sensor to directly detect a motion path of the mobile phone 100 to generate a corresponding control signal S_{C}. The detector 110 can be implemented using an image capturing device (not shown) in conjunction with a logical computation unit (not shown). The logical computation unit can determine the motion path of the mobile phone 100 by performing a specific algorithm according to the images captured by the image capturing device, and then generate a corresponding control signal S_{C}.

In conclusion, by detecting a motion path of a mobile phone to generate a control signal to mix music, a user can mix their own music when moving their body without the inconvenience caused by the keyboard input.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for mixing music, comprising:
(a) utilizing a portable device to play an audio file;
(b) detecting a motion path of the portable device to generate a control signal; and
(c) mixing the audio file according to the control signal in order to mix a specific sound effect with a sound effect corresponding to the audio file, wherein the specific sound effect is selected from a plurality of sound effects.

2. The method of claim 1, wherein the audio file comprises a plurality of sections, and step (b) comprises detecting a motion path of the portable device each time the portable device plays a section.

3. The method of claim 2, further comprising:
detecting whether a control signal has been triggered;
wherein step (a) comprises repeatedly playing the sections before the control signal is triggered, and step (c) comprises re-mixing each section according to a control signal generated in each section according to step (b).

4. The method of claim 3, wherein the portable device is a mobile phone, and the control signal is triggered by a button, a sliding shell or a clamshell of the mobile phone.

5. The method of claim 1, wherein the portable device is a mobile phone.

6. A portable device capable of mixing music, comprising:
a storage device for storing an audio file;
a control circuit, coupled to the storage device, for playing the audio file; and
a detector, coupled to the control circuit, for detecting a motion path of the portable device to generate a control signal;
wherein the control circuit mixes the audio file according to the control signal to mix a specific sound effect with a sound effect corresponding to the audio file.

7. The portable device of claim 6, wherein the audio file comprises a plurality of sections, and the detector detects a motion path of the portable device each time the portable device plays a section.

8. The portable device of claim 7, further comprising:
a control signal triggering unit for triggering a control signal;
wherein the control circuit repeatedly plays the sections before the control signal is generated, and the control circuit re-mixes each section according to a control signal generated by the detector in each section.

9. The portable device of claim 8, wherein the portable device is a mobile phone, and the control signal triggering unit is a button, a sliding shell or a clamshell of the mobile phone.

10. The portable device of claim 6, wherein the portable device is a mobile phone.

11. The portable device of claim 6, wherein the detector is a motion sensor.

12. The portable device of claim 6, wherein the detector comprises an image capturing device and a logical computation unit, the image capturing device continuously captures a plurality of images when the portable device moves, and the logical computation unit generates the control signal by determining the images using an algorithm.
